(19) United States
(12) Patent Application Publication
(10) Pub. No.: US 2005/0154504 A1
(43) Pub. Date: Jul. 14, 2005

(54) Vehicles and control systems thereof with adjustable steering axes

(76) Inventor: Nicholas Fenelli, Trenton, NJ (US)

Correspondence Address: HALL, MYERS, VANDE SANDE & PEQUIGNOT, LLP, 10220 RIVER ROAD, SUITE 200, POTOMAC, MD, 20854, US

(21) Appl. No.: 10/953,072

(22) Filed: Sep. 30, 2004

Related U.S. Application Data
(60) Provisional application No. 60/506,723, filed on Sep. 30, 2003.

(51) Int. Cl. G06F 17/00

(52) U.S. Cl. 701/1

(57) ABSTRACT

Systems and methods for variably locating the steering axis of vehicles for achieving improved maneuverability thereof. More particularly, in some embodiments, systems and methods for automatically locating the steering axis (the steer center) of wheeled vehicles according to predetermined and/or detected input variables. In still further embodiments, systems and methods for manually locating the steering axis of a wheeled vehicle. In yet further preferred embodiments, such methods or systems are employed in vehicles utilizing omni-directional wheel systems, skid steer wheel systems, conventional wheels, or combinations thereof.

### RELATED APPLICATION DATA

This application claims priority of U.S. Provisional Patent Application No. 60/506,723, filed Sep. 30, 2003, applied for by Nicholas E. Fenelli, entitled VEHICLE WITH ADJUSTABLE STEERING AXIS, the entirety of which is hereby incorporated by reference.

### FIELD OF THE INVENTION

This invention relates to wheeled vehicles having locationally variable steering axes. More particularly, this invention relates to wheeled vehicles having steering axes (steer centers) the locations of which can be automatically defined according to predetermined or detected criteria, or which may be operator defined as desired. In preferred embodiments, this invention relates to omni-directional vehicles, employing omni-directional wheels, said vehicles having such locationally variable steering axes.

### BACKGROUND OF THE INVENTION

Heretofore, in known control systems for wheeled vehicles, it is typical for such control systems to locate the steer center of the vehicle being controlled (i.e. the steering axis of the vehicle) at the geometric center of the wheel pattern. In this regard, the geometric center of the wheel pattern of a four wheeled vehicle can be found by locating the point of intersection of lines drawn from the left front wheel to right rear wheel and from the right front wheel to left rear wheel (the vertical steer axis being located at such point of intersection).

In vehicles employing such control systems, therefore, the control system recognizes or designates the steer center (steer axis) as being located at the geometric center of the vehicle and performs all steering functions based on such location thereof.

It has been discovered, however, that a vehicle which has a steering axis fixed at its' geometric center is extremely limited in speed and/or dynamic stability. Furthermore, the ability of the vehicle operator to walk behind such vehicles when carrying long loads, for example, is difficult and/or limited. In this regard, when traveling at significant forward speeds, steering or turning a vehicle can introduce significant instability to the vehicle particularly if the vehicle is carrying heavy or unstable loads.

Moreover, for vehicles with rotational capabilities, such as omni-directional or skid steer type vehicles, although it is possible to maneuver such vehicles in a variety of rotational type directions, it is often the case that maneuvering about an object, for example, can require complicated control maneuvers (e.g. with a joystick) and/or can require significant concentration of the vehicle operator. Examples of particularly innovative omni-directional vehicles can be found in U.S. Pat. Nos. 6,340,065; 6,394,203; and 6,547,340, such patents being co-owned herewith, the disclosures of which are hereby incorporated by reference.

In response to the above enumerated drawbacks, Applicant has developed systems and methods by which the steering axis or steer center of a vehicle can be located or moved, automatically, or manually as desired, thereby to address and/or solve the above mentioned problems. In this regard, Applicant has developed methods and systems by which the steer center of a wheeled vehicle can be assigned or moved in response to one or more of a plurality of criteria, such as, for example, vehicle speed and/or vehicle load (including a vehicle's center of gravity due to load) such as to maximize or optimize a vehicles dynamic stability.

Furthermore, Applicant has developed methods and systems by which increased ease of maneuverability of a vehicle can be achieved, such as by allowing the assignment of the location of a steer center to permit ease of rotation about a fixed object, for example, without requiring that complicated control maneuvers be performed by an operator (or, in some cases, no control maneuvers are required to be performed at all).

In view of the above-enumerated drawbacks, it is apparent that there exists a need in the art for systems and/or methods which solve and/or ameliorate at least one of the above problems of prior art vehicle control systems. It is a purpose of this invention to fulfill these needs in the art as well as other needs which will become more apparent to the skilled artisan once given the following disclosure.

### SUMMARY OF INVENTION

Generally speaking, this invention fulfills the above described needs in the art by providing:
a method of controlling the directional motion of a vehicle in response to at least one selected or detected variable, the method comprising:
variably locating a steer center, corresponding to a steer axis, of a vehicle in response to the at least one selected or detected variable.

In further embodiments, this invention provides:
a system for controlling the directional motion of a vehicle in response to at least one selected or detected variable, the system comprising:
a control mechanism embodying a set of control instructions, the control instructions being formulated to perform the functions of:
variably locating a steer center, corresponding to a steer axis, of a vehicle in response to the at least one selected or detected variable.

Preferred embodiments of the subject invention relate generally to the field of vehicle computer or microprocessor control systems for omni-directional and skid steered (or directionally steered) vehicles (including algorithms associated therewith). In certain embodiments, this invention relates to a control methodologies designed to be used for walk-behind, relatively stationary, or ride-on machinery such as fork lifts, cranes, pallet trucks, long load transporters, aircraft handling or aircraft engine handling devices, aerial work platforms, and other industrial machinery, as well as medical equipment including wheelchairs, scooters, patient lifts, beds, stretchers, transport dollies or other powered ambulatory equipment and personal mobility devices.

In various preferred embodiments, the subject invention provides a methodology to interrelate various variables defining the wheel motion definitions required for a vehicle to perform a prescribed combination of translational and rotational motions. For example, various algorithms can be used to obtain a plurality of different desired results (exemplary mathematical representations of such interrelationships of the variables are provided in the description below).

Example functionalities to which certain particularly efficacious methods of the subject invention apply are as follows:

a) Steer Center Determination, which is a method for causing a vehicle to rotate around a vertical steer axis other than that located at the geometric center of the wheel pattern. Previous control algorithms have had the center of rotation fixed at the center of wheel arrangement. This method permits the center of rotation to be defined anywhere in the plane of the vehicle's motion. An example provided herein below demonstrates the center of rotation being defined anywhere on the longitudinal centerline of the vehicle between the front axle center and the geometric center of the tread rectangle. The steering axis is the point around which the vehicle rotates.

b) Variable Steer Center, which is a method for actively moving the steer axis of a vehicle as a function of rotational speed, translational speed, preprogrammed definition, or other external input. In this example, the steering axis can be actively moved as a function of dependant variables having any specified (or unspecified) range. The example provided herein varies the scaling of the distance from the center of the front axle, to the center of rotation, between the maximum value of half the length of the wheel base, to the minimum value of zero. The scaling is a function of the Y input command (fwd/rev) such that when Y is zero, the turn center distance is a specified amount (B), and when Y is maximum, the turn center distance is maximum (WB/2). This has the effect of reducing “tail swing” as speed increases. In particular, this example exhibits the added benefit of increased dynamic vehicle stability.

c) Rotational Speed Limit, which is a method to limit rotational speed as a function of translational speed, preprogrammed definition, or other external input. In this example, the rotational speed can be limited as a function of dependant variables having any specified (or unspecified) range. The example provided herein varies a parameter that limits the rotational (Z axis) maximum motor speed command to a fraction of an external setting.

d) Dependent Speed Limiting, which is a method to limit a translational speed as a function of rotational speed, another translational speed, preprogrammed definition, or other external input. In this example, the limiting of the translational speed can be a function of dependent variables having any specified (or unspecified) range. In the example provided herein, speed in the X direction (sideways) is limited as a function of the speed in the Y direction (fwd/rev) such that X would be at maximum when Y is zero and would reduce linearly to a fixed specified value when Y is at maximum. Similarly, in this example, rotation speed would be limited from a maximum to a fixed value as a function of an increase in the translation command vector (vector summation of X and Y). This type of speed limiting and can be referred to as “Speed Sensitive Steering”. Specifically, this function is a safety feature that, when operating, requires more input to get a certain yaw rate at high speed (relative to lower speeds), and provides an ergonomic benefit, for example, by achieving a large yaw rate from a small input at slower maneuvering speeds.

e) Dynamic Scaling, which is a method to actively rescale input signals as a function of dependant relationships, in order to maximize input device resolution.

It is one object of the subject invention to employ dynamic scaling to tailor the amount of power provided to sideways directional movement as a function of forward or reverse directional movement (or vice versa). For example, when traveling at high forward speeds, sideways speed is limited according to a formula such as provided herein.

It is a further object of one embodiment of the subject invention to provide a manually operated joystick. In such an embodiment, for example, the sensitivity of the joystick can optionally be reprogrammed following scanning cycles for input variables e.g. every 20-40 milliseconds. In effect, using such an embodiment, the range of motion of the joystick, as it corresponds to output power, is variable continuously based on the input variables (e.g. speed or load conditions) i.e. to improve or optimize joystick resolution for one or more input variables.

It is yet a further object of the subject invention to provide a system in which a single command can be employed to perform desired vehicle directional functions e.g. to cause the rotation of a vehicle about an object with a single control input.

The invention will now be described with respect to certain embodiments thereof as illustrated in the following drawings wherein:

### BRIEF DESCRIPTION OF THE DRAWINGS

FIG. 1 illustrates a plan view of a wheeled vehicle having a steer center located at the geometric center of an omni-directional vehicle in accordance with known vehicle control systems.

FIG. 2 illustrates a plan view of one embodiment of a steer axis location control system according to the subject invention, with the steer center being shown located forward of the geometric center of the vehicle.

FIG. 3 illustrates a plan view of an alternative embodiment of the subject invention in which the steer center of a vehicle is variably located (moved) in response to or as a function of input or detected variables such as vehicle speed.

FIG. 4 illustrates, in graphical form, one embodiment of a speed vs. steer center location relationship determination such as performed in the embodiment of FIG. 3.

FIG. 5 is an alternative embodiment of the subject invention, illustrated in graphical form, in which a speed vs. steer relationship is calculated to improve, maximize, and/or optimize dynamic stability of a vehicle during vehicle locomotion.

FIG. 6 illustrates an embodiment of the steer center control system according to the subject invention in which the steer center is assigned within an object within the plane of directional motion of the vehicle.

FIG. 7 illustrates an embodiment of the steer center control system according to the subject invention in which the steer center is assigned at the location of the vehicle operator as determined by the sensing of the location of a sensor located proximal or on the vehicle operator.

### DETAILED DESCRIPTION OF CERTAIN EMBODIMENTS

For a more complete understanding of the present invention and advantages thereof, reference is now made to the following description of various illustrative and non-limiting embodiments thereof, taken in conjunction with the accompanying drawings in which like reference numbers indicate like features.

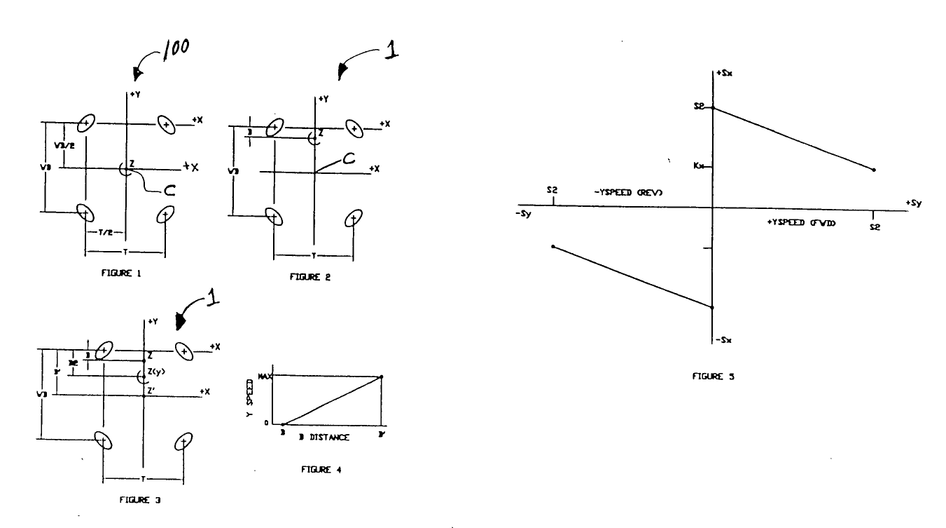

Turning now initially to FIG. 1, therein is illustrated, in plan form, a prior art vehicle control system 100 in which the steer center of a vehicle is located at the geometric center of the vehicle. More specifically, as can be seen in this figure, the geometric center of the vehicle is located at point Z, along the longitudinal centerline of the vehicle at a distance of one half of the wheel base from the centerline of the front axle. For the purposes of the mathematics of the example provided herein, rotation about the steer axis at point Z is considered positive when clockwise. The Y+direction indicated in FIG. 1 is considered the forward direction, and the X+direction is to the right.

As aforesaid in the BACKGROUND section above, such a prior art control system suffers from various drawbacks, some of which are related to lack of dynamic stability, which, in turn, limits the top speed of the vehicle.

Referring now, then, to FIG. 2, therein is illustrated, in plan view, one embodiment of a steer axis location control system 1 according to the subject invention, with the steer center Z being shown located forward of the geometric center C of the vehicle. In such an embodiment, wheel motion (e.g. speed and direction) requirements can be calculated through transformation equations for any location of Z on the x-y plane. In this regard, the example in FIG. 2 shows Z at a location along the longitudinal centerline of the vehicle, an arbitrary distance B from the centerline of the front axle.

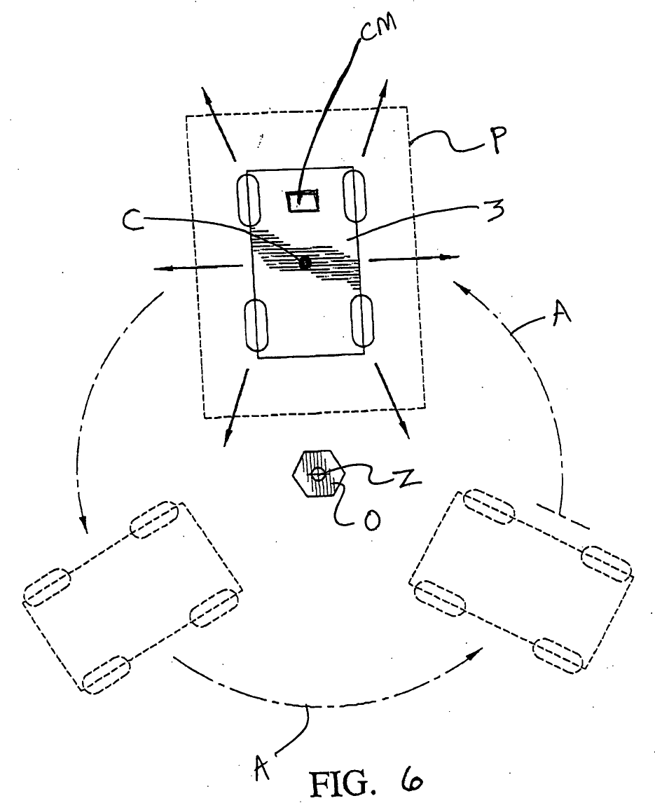

FIG. 3, in comparison to the first two figures, depicts an example of a variable steer center embodiment of the steer axis location control system 1 wherein steer center Z is not fixed at location B, but, rather, is permitted to move around in the x-y plane as a function of other variables. Moreover, in the example, steer center Z(y) is moved as a function of speed Y (e.g. forward/reverse) along the longitudinal centerline of the vehicle between an arbitrary point Z at a distance B from the center of the front axle to a point Z′ at distance B′ (=WB/2) from the center of the front axle.

Turning now to FIG. 4, this figure depicts an embodiment, in graphical form, of steer axis location control system 1 wherein the speed vs. steer center location relationship determination (e.g. such as described with respect to FIG. 3). In such an embodiment, any logical or appropriate mathematical definition and/or any polynomial order can be used calculated from or as a function of any number of inputs (e.g. detected variables). Furthermore, as can be seen, the graph of the subject embodiment defines the location of steer center Z as a linear (first order) function of the translational speed in a forward/reverse direction. In the example embodiment, when the Y Speed is zero, steer center Z is at distance B from the center of the front axle. As speed Y increases, steer center Z moves closer to the geometric center of the vehicle. When speed Y is at its maximum, the steer center reaches distance B′.

In certain further embodiments, such as illustrated in FIG. 5, steer axis location control system 1 determines and/or manages the location of steering center Z by a method and/or system in which dependant speed limiting of translation in the X (e.g. sideways) direction is a function of speed in the Y direction (e.g. forward/reverse). In such an embodiment, any logical or appropriate mathematical definition and/or any polynomial order can be used calculated from or as a function of any number of inputs (e.g. detected variables). Moreover, in such an embodiment, sideways speed is determined/calculated as a linear (first order) function of forward/reverse translational speed. When speed Y is zero, the maximum sideways speed S2 is permitted. As speed Y increases, allowable speed X is reduced. When speed Y is at its maximum, allowable speed X reaches value Kx. Additionally, in the example, the limitation of speed Z (rotational speed) is an analogous function of speed Y where the lower limit is defined as Kz.

In still further embodiments, such as illustrated in FIG. 6, steer center Z of vehicle 3 is assigned to an object 0 located outside the parameters of vehicle 3 (by control mechanism CM) but within plane of motion P which, in preferred embodiments, extends outwardly from the wheel contacting surface of vehicle 3 indefinitely. In such an embodiment, it is conceivable to locate or assign steer center Z anywhere in plane of motion P regardless of the distance of steer center Z from geometric center C of vehicle 3 (i.e. the location of steer center Z is not limited to within the “four corners” of the wheels). As illustrated by the rotation arrows A in the figure, after assigning the location of steer center Z, vehicle 3 can be rotated about object 0 automatically such as by manually inputting a single input signal or automatically, as desired.

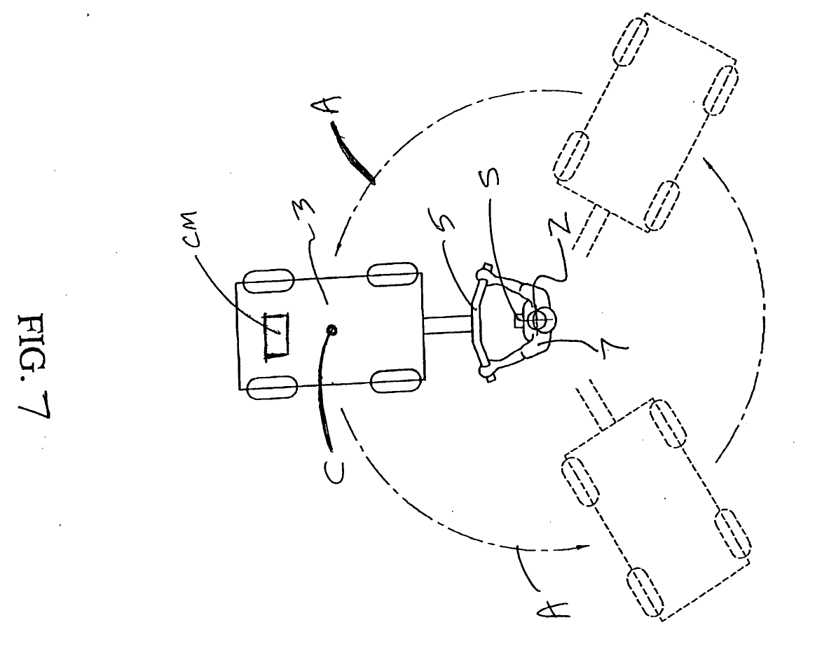

In yet another embodiment, as shown in FIG. 7, in a walk behind version of vehicle 3 employing a control handle 5, as illustrated, control mechanism CM can automatically, or by manual operation, assign steer center Z at a location corresponding to the location of a human vehicle operator 7. In a preferred embodiment of FIG. 7, the location of operator 7 is constantly or periodically monitored and/or detected using a sensor S located on or proximal the operator. Afterwards, vehicle 3 can be rotated about operator 7 automatically, again, such as by manually inputting a single input signal or automatically, as desired. In such an embodiment, by assigning the location of the steer center of the vehicle as such, walk behind-type vehicles can be rotated without requiring that vehicle operator “run around” the vehicle as would be required if the vehicle were rotated about its geometric center C.

In further preferred embodiments, when a load carrying vehicle is being operated, the center of gravity of such a load carrying vehicle can be automatically or manually recalculated so that steer center Z can be located as a function of the position thereof. In such embodiments, locating steer center Z as such allows vehicle 3 to be operated in a manner which is dynamically stabilized (e.g. preferably optimally). For example, in one such embodiment, steer center Z would be continually monitored and/or repositioned as the center of gravity of vehicle 3 is caused to change (e.g. during monitoring cycles).

Example Equations Demonstrating Each Method:

Definitions of variables used in examples and in the drawings:
1) Wheelbase—WB
2) Tread Width—T
3) Turn Center Distance—B
4) Rotation Speed Reduction Factor—R (%)
5) X Intercept speed—Kx, the max. allowable X direction speed at max. Y speed
6) Z Intercept Speed—Kz, the max. allowable rotational speed at max. Y speed
7) Maximum Vehicle Speed—S, Y direction speed (Fwd/Rev)
8) Proportional Input Values—P(X,Y,Z)(1,2,3,4) range definitions (0-255)
9) Discrete Input Value—P Limit on maximum speed in percent.

The sequence of method logic for this example is:
1) Determine number of significant units on each of six input axes, between neutral zone, and max. valid value, and a direction indicator.

2) Calculate the Speed Limits for translation and rotation by applying predetermined or input restrictions.

3) Calculate the Relative Limits for each of six axes by modifying the Speed Limits by applying the joystick position slope intercept relationship equations.

4) Compute six scaling factors by proportioning the relative limits over the available range of scaling units.

5) Compute six values of wheel speed by multiplying scaling factor by the corresponding joystick command.

6) Determine the steer center location based on the Y input.

7) Calculate the steer correction factor for the current steer center location.

8) Solve the superposition matrix to obtain four speed and direction commands, one for each wheel.

9) Send speed and direction commands to the drive.

The equations required for each of the steps above are as follows:

1) Speed Limits: S2=S×P S3=S2×R
2) Relative Limits: In the slope intercept form Y=m×X+b
   Sx+=(−1×(S2−Kx)/(PY4−PY3)×|Y|)+S2
   Sx−=(−1×(S2−Kx) (PY2−PY1)×|Y|)+S2
   Sy+=S2
   Sy−=S2
   Sz+=((−1×(S3−Kz)/((PY4−PY3)×1.4142))×((X²+Y²)^{0.5}))+S3
   Sz−=((−1×(S3−Kz)/((PY2−PY1)×1.4142))×((X²+Y²)^{0.5}))+S3
3) Scaling factors:

+Xscale=Sx+/(PX4−PX3)
−Xscale=Sx−/(PX2−PX1)
+Yscale=Sy+/(PY4−PY3)
−Yscale=Sy−/(PY2−PY1)
+Zscale=Sz+/(PZ4−PZ3)
−Zscale=Sz−/(PZ2−PZ1)
4) Wheel Speed Values:
   +Xspeed=|X|x+Xscale
   −Xspeed=|X|×−Xscale
   +Yspeed=|Y|x+Yscale
   −Yspeed=|Y|×−Yscale
   +Zspeed=|Z|x+Zscale
   −Zspeed=|Z|×−Zscale
5) Steer Center Determination:
   B2=(((WB/2)−B)/(PY4−PY3))×((X²+Y²)^{0.5})+B
6) Steer Center Corrections:
   FAM=(((T/2)²+B2²)^{0.5})/(((T/2)²+(WB/2)²)^{0.5})
   RAM=(((T/2)²+(WB−B2)²)^{0.5})/(((T/2)²+(WB/2) 2)^{0.5})
7) Apportioned Wheel Speed Values:
   LF=Xspeed+Yspeed+(Zspeed'FAM)
   RF=Xspeed+Yspeed+(Zspeed'FAM)
   LR=Xspeed+Yspeed+(Zspeed×RAM)
   RR=Xspeed+Yspeed+(Zspeed×RAM)

Note that the variables in the above equations are not signed, nor are axis specific speeds designated. These should be determined through proper logic within the program and must include corrections to signs (i.e. +/−) for motor reversal required by vehicle structure.

Once given the above disclosure, many other features, modifications, and improvements will become apparent to the skilled artisan. Such other features, modifications, and improvements are therefore considered to be part of this invention, the scope of which is to be determined by the following claims:

1. A method of controlling the directional motion of a vehicle in response to at least one selected or detected variable, said method comprising:
variably locating a steer center, corresponding to a steer axis, of a vehicle in response to said at least one selected or detected variable.

2. A method according to claim 1 wherein said vehicle is a wheeled vehicle employing independently driven wheels.

3. A method according to claim 1 wherein said vehicle is a wheeled vehicle employing independently driven wheels selected from the group consisting of:
omni-directional-type wheels and skid steer type wheel systems.

4. A method according to claim 3, wherein said vehicle includes a plurality of wheels, said wheels being located in a pattern, said pattern having a geometric center, said method further comprising locating said steer center of said vehicle at a location other than said geometric center of said wheel pattern of said vehicle.

5. A method according to claim 4 wherein said vehicle travels in a plane of motion and wherein said steer center of vehicle is selectively locatable anywhere in said plane of motion of said vehicle.

6. A method according to claim 5 further comprising actively moving said steer center of said vehicle, as desired, and performing said movement of said steer center in response to detection of one or more variables selected from the group consisting of:
rotational speed, translational speed, preprogrammed definition, or other external input variables.

7. A method according to claim 4 further comprising: setting a rotational speed limit of said vehicle based on determining or detecting a translational speed thereof, a preprogrammed definition, or other external input variable.

8. A method according to claim 6 wherein said plane of motion is defined by an area not limited to an area among or between said vehicle wheels.

9. A method according to claim 5 further comprising methods steps to maneuver said vehicle rotationally about an object, said method steps comprising:
selecting an object at a location other than said vehicle or a component thereof;
designating said object as said steer center of said vehicle; and
maneuvering said vehicle about said object by rotating said vehicle about said steer center of said vehicle.

10. A method according to claim 9 further comprising automatically rotating said vehicle about said steer center, without operator intervention, after actuation of a control mechanism of said vehicle.

11. A method according to claim 10 further comprising the method steps of:
adding a non-rotational component to a movement of said vehicle as said vehicle rotates about said steer center thereof.

12. A method according to claim 11 wherein said non-rotational component is added by operator intervention.

13. A method according to claim 5 further comprising method steps to maneuver said vehicle rotationally about an operator thereof, said method steps comprising:
determining a location of said vehicle operator;
designating an area proximal said location of said vehicle operator as said steer center of said vehicle; and
rotating said vehicle about said operator.

14. A method according to claim 13 further including the method steps of:
locating a sensor on said vehicle operator;
sensing a location of said vehicle operator according to a detected position of said sensor;
designating an area proximal said location of said detected position of said sensor as said steer center of said vehicle; and
rotating said vehicle about said operator.

15. A method according to claim 12 further comprising limiting a translational speed of said vehicle as a function of rotational speed, a second translational speed, a preprogrammed definition, or other external input.

16. A method according to claim 15 further comprising a method of dynamically scaling vehicle control comprising: actively resealing input signals as a function of dependant relationships thereof, in order to maximize input device resolution.

17. A method according to claim 16 further comprising:
detecting vehicle forward speed as one of said input signals; and
moving said steer center of said vehicle in a direction toward said direction of forward motion in an amount proportional to a magnitude of said forward speed.

18. A method according to claim 17 wherein said movement of said steer center in said forward motion direction is automatically performed by said vehicle.

19. A method according to claim 17 wherein said movement of said steer center in said forward motion direction is manually performed by an operator of said vehicle.

20. A method according to claim 9 wherein vehicle rotation about said steer center is accomplished by an operator providing a single input to a control mechanism of said vehicle.

21. A system for controlling the directional motion of a vehicle in response to at least one selected or detected variable, said system comprising:
a control mechanism embodying a set of control instructions, said control instructions being formulated to perform the functions of:
variably locating a steer center, corresponding to a steer axis, of a vehicle in response to said at least one selected or detected variable.

22. A system according to claim 1 wherein said vehicle is a wheeled vehicle employing independently driven wheels.

23. A system according to claim 1 wherein said vehicle is a wheeled vehicle employing independently driven wheels selected from the group consisting of:
omni-directional-type wheels and skid steer type wheel systems.

24. A system according to claim 3, wherein said vehicle includes a plurality of wheels, said wheels being located in a pattern, said pattern having a geometric center, and wherein said location of said steer center of said vehicle is at a location other than said geometric center of said wheel pattern of said vehicle.

25. A system according to claim 24 wherein said vehicle travels in a plane of motion and wherein said steer center of vehicle is selectively locatable anywhere in said plane of motion of said vehicle.

26. A system according to claim 25 wherein said control mechanism is capable of actively moving said steer center of said vehicle, as desired, and performing said movement of said steer center in response to detection of one or more variables selected from the group consisting of:
rotational speed, translational speed, preprogrammed definition, or other external input variables.

27. A system according to claim 24 further wherein said control mechanism is capable of:
setting a rotational speed limit of said vehicle based on determining or detecting a translational speed thereof, a preprogrammed definition, or other external input variable.

28. A system according to claim 26 wherein said plane of motion is defined by an area not limited to an area among or between said vehicle wheels.

29. A system according to claim 25 wherein said control mechanism, embodying said control instructions, is capable of:
selecting or allowing a selection of an object at a location other than said vehicle or a component thereof;
designating said object as said steer center of said vehicle; and
controlling said vehicle thereby to maneuver said vehicle about said object by rotating said vehicle about said steer center of said vehicle.

30. A system according to claim 29 wherein said control mechanism is capable of automatically rotating said vehicle about said steer center, without operator intervention, after actuation of said control mechanism of said vehicle.

31. A system according to claim 30 further wherein said control mechanism is capable of adding a non-rotational component to a movement of said vehicle as said vehicle rotates about said steer center thereof.

32. A method according to claim 31 wherein said non-rotational component is added by manual operation of an operator of said vehicle.

33. A system according to claim 35 wherein said control mechanism is capable of:
determining a location of said vehicle's operator;
designating an area proximal said location of said vehicle's operator as said steer center of said vehicle; and
causing said vehicle to rotate about said operator about said steer center.

34. A system according to claim 33 further including:
a sensor located on an operator of said vehicle; said control mechanism being capable of detecting a location of said sensor and thereby determining a location of said vehicle operator according to said detected position of said sensor; and
said control mechanism being capable of assigning an area proximal said location of said detected position of said sensor as said steer center of said vehicle and thereafter causing said vehicle to rotate about said operator about said steer center.

35. A system according to claim 32 further wherein said control mechanism is further capable of actively limiting a translational speed of said vehicle as a function of rotational speed, a second translational speed, a preprogrammed definition, or other external input.

36. A system according to claim 35 wherein said control instructions include instructions for conducting dynamic scaling of vehicle control, said dynamic scaling including actively resealing input signals as a function of dependant relationships thereof, in order to maximize input device resolution.

37. A system according to claim 36 further including a speed detector for detecting a forward speed of said vehicle as one of said input signals; and
wherein said control mechanism, upon receiving information related to said forward speed from said speed detector, is capable of moving said steer center of said vehicle in a direction toward said direction of forward motion in an amount proportional to a magnitude of said forward speed.

38. A system according to claim 37 wherein said control mechanism is capable of moving said steer center in said forward motion direction automatically without operator intervention.

39. A system according to claim 37 further including an input device communicably connected to said control mechanism, said input device being manually operable by a vehicle operator to move said steer center in said forward motion direction.

40. A system according to claim 39 wherein said control mechanism is capable of causing said vehicle rotation about said steer center upon receipt of a single input signal actuated by a vehicle operator.

41. A method according to claim 4 wherein said steer center is located at a location other than the geometric center such that said vehicle is rotatable about said steer center to facilitate maneuverability of said vehicle about obstacles.

42. A method according to claim 4 wherein said steer center is located at a location other than the geometric center such that said vehicle is steerable about said steer center to facilitate increased dynamic stability of said vehicle.

43. A system according to claim 24 wherein said steer center is located at a location other than the geometric center such that said vehicle is rotatable about said steer center to facilitate maneuverability of said vehicle about obstacles.

44. A system according to claim 4 wherein said steer center is located at a location other than said geometric center such that said vehicle is steerable about said steer center to facilitate increased dynamic stability of said vehicle.

45. A method according to claim 16 wherein said step of actively resealing input signals substantially eliminates input dead zones in manually operable input controls mechanism.

46. A system according to claim 36 wherein said instructions for conducting active resealing of input signals, when performed, substantially eliminate input dead zones in a manually operable input controls mechanism.

47. A system according to claim 46 wherein said manually operable input control mechanism is a joystick.

48. A method according to claim 1 further including the method step of automatically determining a center of gravity of said vehicle as a function of vehicle load position and weight, and automatically locating said steer center at said center of gravity.

49. A system according to claim 21 further wherein said control mechanism is capable of automatically determining a center of gravity of said vehicle as a function of vehicle load position and weight, and thereafter automatically locating said steer center at said center of gravity.
